(19) United States
(12) Patent Application Publication
(10) Pub. No.: US 2026/0079681 A1
(43) Pub. Date: Mar. 19, 2026

(54) MULTI-PLATFORM DESIGN MANAGEMENT AND DEPLOYMENT

(71) Applicant: DISH Network L.L.C., Englewood, CO (US)

(72) Inventors: Puttaraju Munirathnam, Englewood, CO (US); Brandon Melchior, Denver, CO (US); David Wyffels, Centennial, CO (US); Erik Nava, Denver, CO (US); Luke Sydow, Denver, CO (US); Matthew Hardy, Denver, CO (US)

(73) Assignee: DISH Network L.L.C., Englewood, CO (US)

(21) Appl. No.: 18/890,426

(22) Filed: Sep. 19, 2024

(51) Int. Cl. G06F 8/41; H04L 67/00

(52) U.S. Cl. CPC G06F 8/425; H04L 67/34

(57) ABSTRACT

A design management and distribution system can include a design system configured to generate an update to a UI design comprising components, variables, and variants. A design pipeline can be configured to tokenize the components, variables, and variants of the UI design to generate tokenized code stored in a structured data format in a design repository. The system can include an application pipeline configured to translate the tokenized code into a first platform-specific package compatible with a first client device and into a second platform-specific package compatible with a second client device. The first platform-specific package and the second platform-specific package implement the UI design. A first application repository may receive the first platform-specific package from the application pipeline for distribution to the first client device, and a second application repository may receive the second platform-specific package from the application pipeline for distribution to the second client device.

### TECHNICAL FIELD

The following generally relates to designing and deploying user interfaces. More particularly, the following relates to systems, devices, and automated processes that automatically propagate interface designs to present a uniform experience across multiple applications and platforms.

### BACKGROUND

In the realm of user interface (UI) design, ensuring consistent propagation of updates and designs across multiple platforms poses significant challenges. One primary difficulty lies in accommodating diverse themes and branding identities inherent to various platforms. For instance, mobile applications often adopt distinct design languages compared to their web counterparts, necessitating tailored UI updates that align with platform-specific guidelines and user expectations. This disparity complicates the seamless integration of new features and design improvements, as UI elements must conform not only to functional requirements but also to aesthetic and interactive norms unique to each platform. Maintaining brand coherence across platforms further exacerbates this challenge, requiring UI designers to strike a delicate balance between consistency and adaptability.

Additionally, implementing interface designs consistently across different computing platforms introduces a host of technical hurdles. Variations in screen sizes, resolutions, input methods, and hardware capabilities demand responsive and adaptive UI solutions. Ensuring that a design renders correctly and performs optimally on a wide variety of devices ranging from smartphones and tablets to desktop computers and wearable gadgets requires meticulous planning and execution. The rapid evolution of operating systems and their associated UI frameworks necessitates frequent updates and adaptations, which can strain development resources and introduce compatibility issues. Addressing these complexities requires robust strategies for version control, testing frameworks, and deployment methodologies to guarantee a cohesive user experience irrespective of the device or platform employed.

### BRIEF SUMMARY

Systems, methods, and devices of the present disclosure can streamline interface design and propagation while unifying user experiences across numerous otherwise incompatible platforms. An example process can include detecting, by a design pipeline, a new version of a user interface (UI) design generated by a design system. The new version of the UI design can include components, variables, and variants. The design pipeline tokenizes the components, variables, and variants of the UI design to generate tokenized code stored in a structured data format in a design repository. The tokenized code can be translated into a first and second platform-specific packages. The first platform-specific package implements the new version of the UI on a first platform, and the second platform-specific package implements the new version of the UI on a second platform. The first platform-specific package can be distributed to a first client device of the first platform, and the second platform-specific package to a second client device of the second platform.

In various embodiments, translating the tokenized code further includes applying a first script to parse the tokenized code and generate the first platform-specific package, and applying a second script to parse the tokenized code and generate the second platform-specific package. The tokenized code can include a primitive token, a semantic token, a component token, and an experience token.

In an example of token-generated UIs, consider a user interface comprising a first native theme and a second native theme. The first client device applies the first native theme in the first platform-specific package to render a first UI of the UI design with a first branding, and it applies the second native theme in the first platform-specific package to render a second UI of the UI design with a second branding. Translating can include making an application programming interface (API) call from the device pipeline to retrieve data related to the components, variables, and variants. The data related to the components, variables, and variants can be encoded into the structured data format as tokens. The tokens can be implemented in platform specific applications.

An example of a design management and distribution system can include a design system configured to generate an update to a user interface (UI) design comprising components, variables, and variants. A design pipeline can be configured to tokenize the components, variables, and variants of the UI design to generate tokenized code stored in a structured data format in a design repository. The system can include an application pipeline configured to translate the tokenized code into a first platform-specific package compatible with a first client device and into a second platform-specific package compatible with a second client device. The first platform-specific package and the second platform-specific package implement the UI design. A first application repository may receive the first platform-specific package from the application pipeline for distribution to the first client device, and a second application repository may receive the second platform-specific package from the application pipeline for distribution to the second client device.

In various embodiments, the first platform-specific package can be incompatible with the second client device of the second platform. A package registry can be configured to publish the tokenized code to the application pipeline. The application pipeline can translate the tokenized code by applying a first script to parse the tokenized code and generate the first platform-specific package, and by applying a second script to parse the tokenized code and generate the second platform-specific package. A motion token may define an easing curve for the user interface in the first platform-specific package and in the second platform-specific package. The first client device can be configured to apply a first native theme in the first platform-specific package to render a first UI of the UI design with a first branding, and the first client device can apply a second native theme in the first platform-specific package to render a second UI of the UI design with a second branding. The design pipeline can be configured to make an application programming interface (API) call to retrieve data related to the components, variables, and variants, and the design pipeline can be configured to encode the data related to the components, variables, and variants into the structured data format.

Another example process can include the steps of generating a new version of a user interface (UI) design comprising components, variables, and variants, tokenizing the components, variables, and variants of the UI design to generate tokenized code, and translating the tokenized code into a first platform-specific package and a second platform-specific package that implement the new version of the UI. The first platform-specific package can be distributed on a first platform. The second platform-specific package can be distributed on a second platform incompatible with the first platform-specific package.

In various embodiments, translating the tokenized code further comprises applying a first script to parse the tokenized code and generate the first platform-specific package, and applying a second script to parse the tokenized code and generate the second platform-specific package. The tokenized code can include a motion token that defines motion parameters for the new version of the user interface. Translating the tokenized code can include calling an API to retrieve data related to the components, variables, and variants, and encoding the data related to the components, variables, and variants into a structured data format.

### DRAWING FIGURES

The subject matter of the present disclosure is particularly pointed out and distinctly claimed in the concluding portion of the specification. A more complete understanding of the present disclosure, however, may be obtained by referring to the detailed description and claims when considered in connection with the illustrations.

FIG. 1 illustrates an example of system for generating and propagating design updates across multiple platforms, in accordance with various embodiments.

FIG. 2 illustrates an example process for generating and propagating design updates across multiple platforms, in accordance with various embodiments.

FIG. 3 illustrates an example system for generating and propagating tokenized themes to interfaces on multiple platforms, in accordance with various embodiments.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

Systems, methods, and devices (collectively, the “System”) of the present disclosure streamline and automate propagation of design updates across multiple platform-specific applications on a variety of platforms. The System enables user interface (UI) designers to design a single UI or user experience (UX) that can then be translated across multiple platforms and brands. As used herein, the term platforms can refer to different codebases and clients. For example, a first platform can include a first codebase compatible with a first device, and a second platform can comprise a second codebase compatible with a second device, but the first codebase may be incompatible with the second device.

Attributes of different design elements may be expressed using various tokens associated with the design elements. The System may apply a theme to the UI as part of a translation process, which translates the tokens into appropriate values for the brand (e.g. Sling TV and DISH) and for the particular platform to generate appropriate code or other applications executable on the platforms. Motion presented in the interface can be tokenized in some examples and translated to present substantially uniformly on different platforms. A single UI design can be compiled into multiple applications and distributed to multiple platforms using the System described herein. The System can thus pass tokenized motion, visual properties, spacing adjustments, and images, all organized under themes, which can also hide or remove UI elements on a per-theme basis.

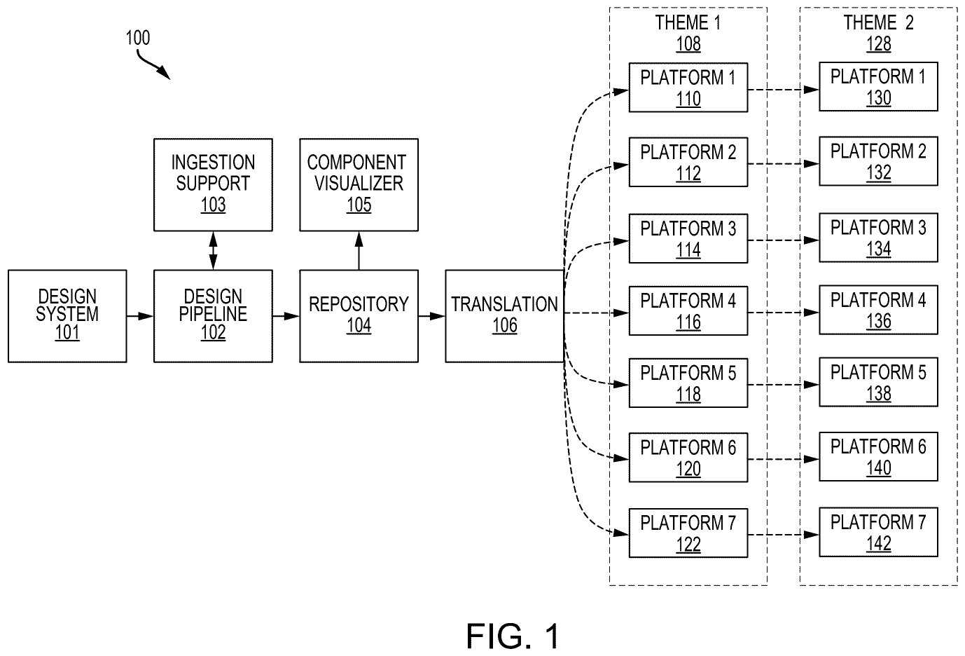

With reference now to FIG. 1, an example system 100 for generating and propagating design updates across multiple platforms, in accordance with various embodiments. System 100 may include a design system 101. Design system 101 can comprise a computer-based system running design software.

In various embodiments, design system 100 and other computer-based systems described herein may comprise a processor in electronic communication with a non-transitory memory configured to store instructions thereon that, when executed by the processor, cause the processor to perform operations. Other computer-based systems in the example of FIG. 1 may include design pipeline 102, ingestion support 103, repository 104, component visualizer 105, translation 106, and platforms 110-122 and 130-142. As used herein, the term pipeline may refer to automated processes performed by a computing system.

The various computer-based systems described herein can run on shared or independent computing resources. For example, the computer-based systems described herein can run using cloud-based computing hardware, a computer, laptop, smartphone, embedded device, set-top boxes (STBs), placeshifting devices, USB devices, game consoles, servers, computing clusters, smart televisions, virtual machines or runtime environments, or other suitable compute resources.

In design system 100, the operations can be related to UI design. Design system 101 can define motion using easing curves and easing duration to consistently apply motion across different themes 108, 128 and platforms 110-122 and 130-142. Design system 101 may use a consistent duration scale for motion to apply standards across various UI components. Design system 101 may define consistent motion patterns that tend to reduce development time and result in a cohesive user experience. Motion tokens can be used during translation to generate platform-specific applications that have consistent motion behavior across a variety of platforms. Motion tokens in some embodiments do not describe typical UI components like other tokens described herein. The motion tokens can be written to the structured files in key-value pairs to describe motion in a UI, for example, along with other UI tokens that describe components. The motion token can include a syntax that described where the motion tokens should be applied and to what type of motion property the motion tokens relate.

In various embodiments, design system 101 may use variables and properties to enable flexibility and control across UI components. Design system 101 can include variables that govern coded components, making quality assurance (QA) on UI designs more efficient. Design system 101 and resulting UIs can be distributed enterprise-wide using system 100, which tends to improve consistency and uniformity in various UIs on different platforms. Design system also tends to improve efficiency in developing and deploying UIs to various platforms.

In various embodiments, design system 101 can set variables and components for different themes 108, 128. For example, design system 101 can set features of labels such as surface radius, stroke radius, typography size, icon size, surface color, icon color, text color, padding, or other UI variables. In some examples, design system 101 can comprise tools made available under the FIGMA trade name.

System 100 may include design pipeline 102 in communication with design system 101. Design pipeline 102 may take automated steps to ingest a new design in response to a triggering action. For example, design system 101 may commit an updated design version to a design repository, which can trigger design pipeline 102 to ingest the new design version. Design pipeline 102 can automated delivery of information guided by ingestion support 103 to retrieve concise information used to build UI components. Automated design parsing scripts may enable quick building and maintenance of UI components.

In various embodiments, design pipeline 103 may be in communication with ingestion support 103 to ingest new or updated designs. For example, design pipeline 102 can include application programming interface (API) calls to a design interpretation service. In an example where design system 101 comprises a FIGMA product, ingestion support 103 may comprise FIGMA rest APIs.

In various embodiments, ingestion support 103 can include libraries or interpretation rules to ingest new or updated designs. Ingestion support 103 can provide relevant styles, variables, images, components, or other UI elements as a new or updated design is ingested from design system 101 for storage in repository 104. Unified designs for the first theme 108 and second theme 128 can be stored in repository 104. Although two themes or brands unified across various platforms are shown in the example of FIG. 1, any number of themes or brands can be incorporated into the UI designs stored in repository 104 to propagate consistent UIs across different platforms 110-122 and 130-142 of theme 108, 128. In some examples, repository 104 can comprise an online repository such as those offered under the GITLAB trade name. Continuing the example, repository 104 and design pipeline 102 can run on the same underlying servers or cloud-computing hardware as a GITLAB pipeline.

In various embodiments, component visualizer can have access to UI components and designs stored in repository 104. Component visualizer 105 can retrieve UIs written to repository 104 to visualize components or other UI elements. Component visualizer 105 can be used to quickly access and QA a design components or a design stored in repository 104. Component visualizer 105 may show UI elements as they will be rendered using theme 108 and theme 128.

In various embodiments, translation 106 may map UI designs stored in repository 104 to themes 108, 128 and platforms 110-122 and 130-142. Translation 106 can maintain consistency in UI appearance, motion, and general experience by generating platform specific applications. Variables and components can be translated by scripts to the various platforms.

In various embodiments, translation can comprise parsing design tokens into a variety of codebases suitable for running on different platforms. Single instances of each UI component can be built for use across the codebase, which tends to decrease duplicate efforts and code. Theme switching can be supported by storing a duplicate component repository with properties differing from one theme to another. The duplicate components may be identified, for example, by a prefix or associated string, which enables quick rendering of the same UI component with theme-appropriate properties.

In the example system 100 of FIG. 1, theme 108 can be presented on platform 110. For example, an accessibility theme can be presented on a platform-specific application or UI compiled to run on particular computing hardware and its accompanying operating system. By running platform-specific applications on client devices of the associated platform, the UI can be distributed across multiple platforms that would otherwise be incompatible with any single application. Theme 128 can be presented on platform 130. For example, theme 128 can be a second or modified native theme compiled to run on the same computing hardware as platform 110.

In various embodiments, themes may be encoded and packaged with platform-specific applications to present in substantially the same manner on different platforms. UIs designed and propagated using system 100 tend to result in substantially uniform UI appearance and theme effect across various computing platforms. As used herein, the phrase native theme may refer to a theme configured to run on multiple platform-specific applications without being significantly altered by the underlying computing hardware or operating systems on which the platform-specific applications run.

As an example, an accessibility theme can be encoded with a Windows compatible application and with an iOS compatible application. The accessibility theme can be applied to both the Windows and iOS applications without using the embedded accessibility settings of the Windows or iOS operating system, since the themes are encoded at a platform-specific-application level.

In another example, the first theme 108 could be the SLING TV brand owned and operated by EchoStar and its subsidiaries, and the second theme 128 could be the DISH NETWORK brand also owned and operated by EchoStar and its subsidiaries. Both branding themes can run on the various platforms, which can run on the same computing hardware and using the same platform-specific applications with different themes.

Continuing the example, the computing hardware that runs platform 110 and platform 130 can comprise a set-top box (STB), platform 112 and platform 132 can comprise a game console, platform 114 and platform 134 can comprise a smart television, platform 116 and platform 136 can comprise an Apple TV device, platform 118 and 138 can comprise an Android TV device, platform 120 and 140 can comprise a FireTV, platform 122 and platform 142 can comprise a Roku device, and other platforms can comprise various streaming devices.

In various embodiments, platform 110 and platform 130 can thus run slightly different UIs generated from the same UI design created in design system 101, while running a similar application on the same underlying hardware but having different themes applied. The UI differences on platform 110 and 130 can comprise theme-based differences. While the above example uses streaming television platforms as an example, system 100 can be used to design and push consistent UI changes for any type of application running on multiple platforms or with multiple themes.

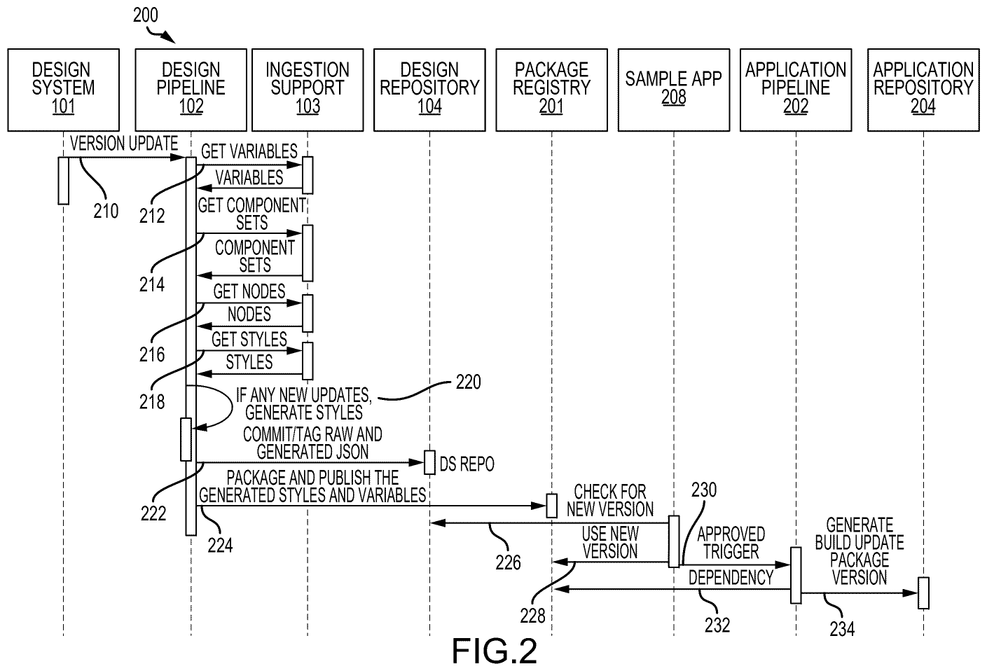

Referring now to FIG. 2, an example process 200 is shown for generating and propagating design updates across multiple platforms, in accordance with various embodiments. Process 200 may comprise generating a version update to a design using design system 101 (Block 210). The design can be platform agnostic and can implement themes to change elements of the UI in a substantially uniform manner across multiple platforms.

For example, a hard-coded subtheme can include a native dark mode and native light mode themes for an application. Light mode and dark mode for platform-specific applications can thus appear substantially similar despite appearing on otherwise different platforms (e.g., same appearance on AppleTV and on Roku), even if the platform implement dark mode and light mode differently at an OS level.

In various embodiments, a hard-coded theme can also include a native accessibility mode. In some examples, users can select or enable native themes. Branding can also be implemented as a theme (e.g., DISH vs. Sling). Design elements can also differ in different themes. For example, colors, shapes, orientation, location on screen, and other design elements can be set in the design.

In various embodiments, the version number of a design can be updated in response to a design being updated or created to reflect the new design. The version update can trigger design pipeline 102 to ingest the new design. In some examples, design pipeline can ingest new designs in response to a time-based trigger. For example, a cron job can run once each night to check for design updates and push updated applications along process 200.

In the example of FIG. 2, design pipeline 102 communicates with ingestion support 103 using an API to get variables (Block 212), to get component sets (Block 214), to get nodes (Block 216), and to get styles (Block 218) along with data associated therewith.

In various embodiments, design pipeline 102 can generate styles in response to design updates (Block 218). The API can return details regarding the variables, components, styles, and other variants for encoding into a structured data format. The UI details returned from the API can be encoded as tokens using structured data formats such as, for example, JSON, HTML, style sheets, tagged data, or other suitable data formats.

Tokens used to encode UI components can include primitive tokens, semantic tokens, component tokens, and experience tokens. Primitive tokens can encode primitive values. For example, primitive tokens can encode a color, Boolean value, stroke, glow value, opacity, dimensions, or other features definable by primitive tokens. Semantic tokens can depend on primitive tokens to implement more complex components based on the primitive tokens. For example, a component might be implemented by a semantic token with a dependency on a primitive token for the color red in portions of a UI. The component can be updated by changing the dependency of the semantic token to depend on a different primitive token encoding the color blue. The resulting UI would display blue instead of red in the encoded locations, and the change would be accomplished by changing a dependency rather than re-coding the various semantic tokens that implement the dependency.

In some embodiments, component tokens can be commonly used for singular (e.g., one off) different component values that deviate from globally encoded component values. However, in some embodiments, component tokens can be used to control size and spacing across an entire theme. The size and spacing of features inside of components can be tied to the size and spacing of the component itself. For example, the curve radius for corners of a square visual component can be tied to the size of the square visual component, such that rounded corners have a radius proportional to the length of the sides of the square visual component. In that regard, any value tied to sizing and spacing can be altered using component tokens. This “misuse” of component tokens tend to improve design efficiency when working with multiple platforms in a manner that typical component tokens, primitive tokens, and semantic tokens cannot. Global component tokens can be used in this way to enable accessibility mode, for example, native to a platform-specific application and consistent across multiple platforms.

In various embodiments, experience tokens can be separate from standard tokens, which are typically linked strictly to components. Experience tokens can be used at the theme, page, or system level. Experience tokens can define changeable parameters for the new version of the user interface. The experience token can include triggered design elements that change the UI in response to user activity in the underlying application. Experience tokens can include syntax that describes when the experience tokens should be applied. Experience tokens can open user access to previously hidden features in the platform-specific applications. Experience tokens can modify the appearance of the UI on the platform-specific applications.

In various embodiments, experience tokens can include, for example, values for page margins, page background color, or toggles for turning on/off visibility of UI elements based on theme. Experience tokens can also include mathematical factors, which can be added into an equation that includes component level or semantic level tokens for the purpose of affecting responsiveness of all UI in a page layout based on viewport size. For example, including the equation (Experience level token of 0.7)×(component image size token of 256) would yield smaller components overall for smaller screens.

For example, an experience token can cause platform-specific UIs to be consistently changed in response to activity within the platform specific application. In one example, a UI can begin with standard coloring. In response to a user viewing an amount of programming exceeding a threshold value in a predetermined time period (e.g., 500 hours over the lifetime of the account), the UI can be changed to have silver coloring. Continuing the example, in response to a user viewing an amount of programming exceeding a second threshold value in a predetermined time period (e.g., 1,000 hours over the past year), the UI can be changed to have gold coloring. Experience tokens can thus affect UI changes in response to user experiences in the platform specific applications.

In some examples, the user experiences in platform-specific applications can be tracked in metadata and stored in a remote database or data store. For example, viewing hours per day for the user can be stored in a central database. The user can log in on a first platform specific application and view programming, and their viewing metadata can be stored centrally. The viewing metadata can be updated in response to the user logging into a second platform specific app on a different platform and viewing additional content. The platform specific applications can check the central repository each time the app is opened or closed to determine whether an experience token should be triggered based on the user's viewing metadata. Data can also be stored locally on the platforms or using other techniques in various embodiments.

In various embodiments, the styles can include tokenized data that describe associated design elements at a code level. The tokens can be written in the foregoing structured data formats in some examples. In some embodiments, tokens can describe motion and can encode motion curves, durations, position changes, rates of change, or other motion-related data. Tokens can be represented in key-value pairs in some embodiments. In some examples, themes can be tokenized and packaged with platform-specific applications. The tokenized data can be used during translation to generate code for multiple platforms (e.g., multiple platform-specific applications) that consistently implement the UI design and UI motion across the platforms. The themes and tokenization tend to result in a substantially uniform user experience across that is insulated from the differences in computing hardware and operating systems of different platforms.

In some embodiments, design pipeline 102 can commit or otherwise deposit styles in design repository 104 (Block 222). Design repository can include versioning information and various versions of a UI design. UI designs can be selectively approved for publication in response to QA, selection, approval, or other publication triggers.

In various examples, design pipeline 102 can package and publish the generated styles and variables in package registry 201 (Block 224). Package registry 201 can be checked during application compilation to pull up-to-date styles and designs into new versions of the platform-specific applications. In some examples, a sample application 208 can be generated using the latest packaged and published styles to QA the latest revisions.

In some embodiments, the application publisher can check for a new version of the design in design repository 104 (Block 226). A new version can be detected by checking the commit date for the latest version, by comparing version numbers for the previously used design with the latest revision, using a flag, or using other techniques. The application publisher can retrieve and use the latest styles and designs from package registry 201 (Block 228).

If application 208 is configured to update in response to an approval, then an approval may trigger application pipeline 202 (Block 230). In some examples, approval of UI design changes may be automatic, though other examples can include manual approval or time-delayed approval. Approval can trigger subsequent compilation and publication of platform-specific applications to application repositories.

In various embodiments, application pipeline 202 can check package registry 201 for dependencies (Block 232). Dependencies can include the latest design version along with any supporting libraries or other supplemental code or other material. Dependencies can be retrieved for inclusion in the resulting platform-specific applications. Application pipeline 202 can generate platform-specific applications, build application packages including native themes, and update the version number to reflect a new build (Block 234).

In some embodiments, each newly built platform-specific application can be stored in application repository 204 for deployment onto corresponding platforms. For example, new application can be made available on the application repository 204 corresponding to platform 116 and platform 136 running the DISH Network and Sling TV branding, respectively, on the same hardware and operating system. In another example, an iOS-specific application can be made available on Apple's App Store repository for installation and use on iOS platforms. The iOS application can include native themes that present a UI uniformly with a Windows application including the same native themes.

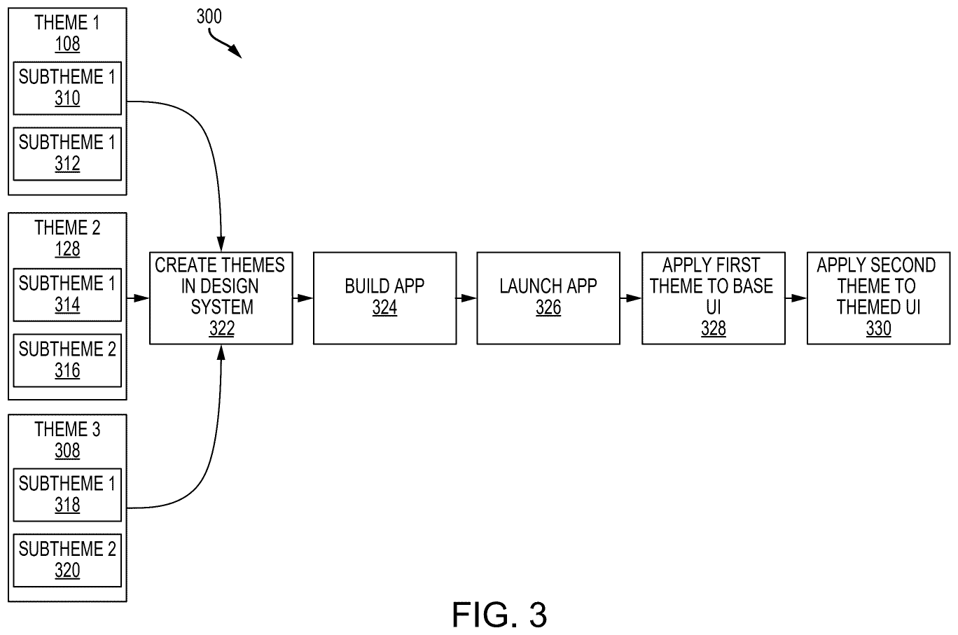

Referring now to FIG. 3, an example process 300 is shown for applying multiple themes, in accordance with various embodiments. Process 300 can include creating themes in design system 101 (Block 322). In the example of FIG. 3, themes 108, 128, 308 are created using design system 101. Theme 108 includes subthemes 310, 312, theme 128 includes subthemes 314, 316, and theme 308 includes subthemes 318, 320. Themes can be applied in layers to generate different UIs than would be generated applying a single theme or subtheme. Themes or subthemes can include cosmetic changes to the user interface in applications selectively applying the themes. For example, themes can include accessibility modes, parental control modes, kid modes, color variations, branding variations, tile variations, button variations, or other interface variations.

In various embodiments, platform-specific applications can be built using the platform-agnostic themes created in design system 101 (Block 324). Applications can be built using system 100 (of FIG. 1) or process 200 (of FIG. 2), for example, to run on platforms 110 and 130 (of FIG. 1) comprising their particular operating system and underlying computing hardware. The application can be configured to apply themes in response to installation, launch, login, or in response to other triggers to apply themes. In the example of FIG. 3, the application can be installed on a compatible platform and launched (Block 326).

In various embodiments, a first theme can be applied to the base UI of the application (Block 328). A second theme can be applied to the modified UI with the first theme applied (Block 330. For example, a kid mode theme or subtheme can be applied followed by an accessibility mode theme or subtheme. The UI resulting from successive application of kid mode and accessibility mode themes might include kid-themed colors with larger text and interface elements. Applicable themes can be applied in response to a trigger, such as launching an application. The application can automatically select themes based on login credentials and associated account data, based on device configurations or settings, based on OS level configuration or settings, based on device capabilities, based on date or time, or based on any other suitable criteria.

Continuing the above example, the kid mode theme may be applied on platform 110 as the first theme in response to parental controls being enabled on the underlying operating system of the platform. The accessibility theme may be applied to UI already modified by the kid mode theme in response to accessibility mode being enabled on the underlying operating system. The themes can be applied at any time, though applying themes during or prior to application launch tends to result in a seamless UX.

In various embodiments, any number of themes or subthemes can be sequentially applied to a platform-specific application. The themes and subthemes can be packaged independently from the base UI design in some embodiments. Themes can be tokenized and packaged directly in platform-agnostic code for translation into platform-specific applications in some examples.

Systems, methods, and devices of the present disclosure tend to propagate a uniform and cohesive UI across multiple platforms where a single application would be incompatible with some of the platforms. UIs can be designed with multiple native themes, which can be packaged with platform-specific applications. The native themes can hard code accessibility differences, appearance differences, branding differences, or other content differences into a variety of platform-specific applications that can run essentially the same UI design on otherwise incompatible platforms.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment (for example, A and B, A and C, B and C, or A and B and C).

References to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device.

What is claimed is:

1. An automated process, comprising:
detecting, by a design pipeline, a new version of a user interface (UI) design generated by a design system, the new version of the UI design comprising components, variables, and variants;
tokenizing, by the design pipeline, the components, variables, and variants of the UI design to generate tokenized code stored in a structured data format in a design repository;
translating the tokenized code into a first platform-specific package and a second platform-specific package, wherein the first platform-specific package implements the new version of the UI on a first platform, wherein the second platform-specific package implements the new version of the UI on a second platform;
distributing the first platform-specific package to a first client device of the first platform; and
distributing the second platform-specific package to a second client device of the second platform.

2. The automated process of claim 1, wherein the translating the tokenized code further comprises applying a first script to parse the tokenized code and generate the first platform-specific package, and applying a second script to parse the tokenized code and generate the second platform-specific package.

3. The automated process of claim 1, wherein the tokenized code comprises a primitive token, a semantic token, a component token, and an experience token.

4. The automated process of claim 3, wherein the tokenized code comprises a motion token that defines an easing curve for motion in the new version of the UI.

5. The automated process of claim 1, wherein the new version of the user interface comprises a first native theme and a second native theme.

6. The automated process of claim 5, further comprising:
applying, by the first client device, the first native theme in the first platform-specific package to render a first UI of the UI design with a first branding; and
applying, by the first client device, the second native theme in the first platform-specific package to render a second UI of the UI design with a second branding.

7. The automated process of claim 1, wherein the translating further comprises:
making, by the design pipeline, an application programming interface (API) call to retrieve data related to the components, variables, and variants; and
encoding the data related to the components, variables, and variants into the structured data format.

8. A design management and distribution system, comprising:
a design system configured to generate an update to a user interface (UI) design comprising components, variables, and variants;
a design pipeline configured to tokenize the components, variables, and variants of the UI design to generate tokenized code stored in a structured data format in a design repository;
an application pipeline configured to translate the tokenized code into a first platform-specific package compatible with a first client device and into a second platform-specific package compatible with a second client device, wherein the first platform-specific package and the second platform-specific package implement the UI design;
a first application repository that receives the first platform-specific package from the application pipeline for distribution to the first client device; and
a second application repository that receives the second platform-specific package from the application pipeline for distribution to the second client device.

9. The design management and distribution system of claim 8, wherein the first platform-specific package is incompatible with the second client device.

10. The design management and distribution system of claim 8, further comprising a package registry configured to publish the tokenized code to the application pipeline.

11. The design management and distribution system of claim 8, wherein the application pipeline translating the tokenized code includes:
applying a first script to parse the tokenized code and generate the first platform-specific package; and
applying a second script to parse the tokenized code and generate the second platform-specific package.

12. The design management and distribution system of claim 8, wherein the tokenized code comprises an experience token that implements an accessibility mode.

13. The design management and distribution system of claim 8, wherein the tokenized code comprises a motion token that defines an easing curve for motion in the first platform-specific package and in the second platform-specific package.

14. The design management and distribution system of claim 8, wherein the first client device is configured to apply a first native theme in the first platform-specific package to render a first UI of the UI design with a first branding, and wherein the first client device is configured to apply a second native theme in the first platform-specific package to render a second UI of the UI design with a second branding.

15. The design management and distribution system of claim 8, wherein:
the design pipeline is configured to make an application programming interface (API) call to retrieve data related to the components, variables, and variants; and
wherein the design pipeline is configured to encode the data related to the components, variables, and variants into the structured data format.

16. A process, comprising:
generating a new version of a user interface (UI) design comprising components, variables, and variants;
tokenizing the components, variables, and variants of the UI design to generate tokenized code;
translating the tokenized code into a first platform-specific package and a second platform-specific package that implement the new version of the UI;
distributing the first platform-specific package on a first platform; and
distributing the second platform-specific package on a second platform incompatible with the first platform-specific package.

17. The process of claim 16, wherein the translating the tokenized code further comprises:
applying a first script to parse the tokenized code and generate the first platform-specific package; and
applying a second script to parse the tokenized code and generate the second platform-specific package.

18. The process of claim 16, wherein the tokenized code comprises a motion token that defines an easing curve for motion in the new version of the UI.

19. The process of claim 16, further comprising:
applying, by a first client device of the first platform, a first native theme in the first platform-specific package to render a first UI of the UI design with a first branding; and
applying, by the first client device of the first platform, a second native theme in the first platform-specific package to render a second UI of the UI design with a second branding.

20. The process of claim 19, wherein translating the tokenized code further comprises:
calling an application programming interface (API) to retrieve data related to the components, variables, and variants; and
encoding the data related to the components, variables, and variants into a structured data format.
